(19) United States
(12) Patent Application Publication
(10) Pub. No.: US 2009/0178078 A1
(43) Pub. Date: Jul. 9, 2009

(54) SYSTEMS, METHODS AND COMPUTER PRODUCTS FOR INDICATORS IN AN INTERACTIVE PROGRAM GUIDE

(75) Inventors: Brian Daigle, Marietta, GA (US); Jerry Liu, Atlanta, GA (US)

Correspondence Address: AT&T Legal Department - CC;Attn: Patent Docketing, Room 2A-207, One AT&T Way, Bedminster, NJ, 07921, US

(73) Assignee: AT&T DELAWARE INTELLECTUAL PROPERTY, INC., Wilmington, DE (US)

(21) Appl. No.: 11/969,562

(22) Filed: Jan. 4, 2008

(51) Int. Cl. G06F 3/00

(52) U.S. Cl. 725/40

(57) ABSTRACT

Systems, methods and computer program products for providing indicators in an interactive programming guide. Exemplary embodiments include a method for displaying an interactive program guide with program status indicators, the method including retrieving a set of program guide entries for the program guide, each of the program guide entries representing programs that have at least one indicator associated with, the program guide entry and illustrating the status of the programs, determining that a subset of the program guide entries represent programs include a particular status that includes a particular status indicator and displaying the status indicator adjacent each program guide entry of the subset of program, guide entries.

### BACKGROUND

Exemplary embodiments relate generally to communications systems, and more particularly, to systems, methods and computer program products for providing indicators in an interactive programming guide.

Internet protocol television (IPTV) is a digital television delivery service wherein the digital television signal is delivered to residential users via a computer network infrastructure using the Internet Protocol. Typically, IPTV services are bundled with additional Internet services, such as internet web access and voice over Internet protocol (VOIP). Subscribers receive IPTV services via a set-top box that is connected to a television or display device for the reception of a digital signal. Used in conjunction with an IP-based platform, the set-top box allows for a subscriber to access IPTV services and any additional services that are integrated within the IPTV service. In addition, DVRs can be coupled to the IPTV-enabled devices in order to record the content available from IPTV.

IPTV service platforms allow for an increase in the interactive services that can be provided to residential subscribers. As such, a subscriber/user can have access to a wide variety of content that is available via the IPTV service or the Internet. For example, a subscriber may utilize interactive services via a set top box to view IPTV content or access their personal electronic messaging accounts via an Internet web browser. The IPTV infrastructure also allows the delivery of a variety of video content instantly to the subscribers. Such content can be recorded on the subscriber's DVR.

Currently, the subscribers interactive programming guide (IPG) does not provide indication on the status of programs that have been recorded, viewed or otherwise managed.

### BRIEF SUMMARY

Exemplary embodiments include a method for displaying an interactive program guide with program status indicators, the method including retrieving a set of program guide entries for the program guide, each of the program, guide entries representing programs that have at least one indicator associated with the program guide entry and illustrating the status of the programs, determining that a subset of the program guide entries represent programs include a particular status that includes a particular status indicator and displaying the status indicator adjacent each program guide entry of the subset of program guide entries.

Additional exemplary embodiments include a system for displaying an interactive program guide, the system including an Internet Protocol-enabled device, a processor for displaying the interactive program guide with program status indicators on the Internet Protocol-enabled device, wherein the processor retrieves a set of program guide entries for the program guide, each of the program guide entries representing programs that have at least one indicator associated with the program guide entry and illustrating the status of the programs, determines that a subset of the program guide entries represent programs include a particular status that includes a particular status indicator and displays the status indicator adjacent each program guide entry of the subset of program guide entries.

Further exemplary embodiments include a computer program for displaying an interactive program guide on an Internet Protocol-enabled device, the computer program product including instructions for causing a computer to implement a method, the method comprising retrieving a set of program guide entries for a program guide, each of the program guide entries representing programs that have at least one indicator associated with the program guide entry and illustrating the status of the programs, determining that a subset of the program guide entries represent programs include a particular status that, includes a particular status indicator and displaying the status indicator adjacent each program guide entry of the subset of program guide entries.

Other systems, methods, and/or computer program products according to embodiments will be or become apparent to one with skill in the art upon review of the following drawings and detailed description. It is intended that ail such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 illustrates a block diagram of an exemplary system for providing IPG indicators;

FIG. 2 illustrates a screen shot of an exemplary interactive programming guide having program status indicators;

FIG. 3 illustrates an example of a screen shot of en exemplary interactive programming guide with sorted indicators; and

FIG. 4 illustrates a How chart, of an IPG indicator method in accordance with exemplary embodiments.

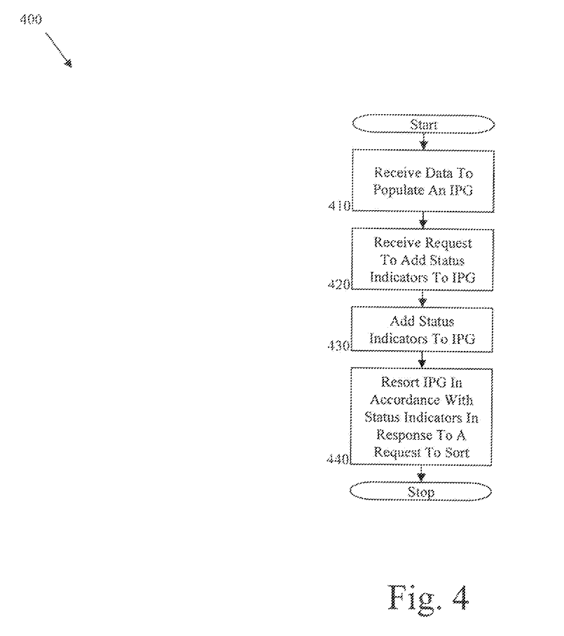

The detailed description explains the exemplary embodiments, together with advantages and features, by way of example with reference to the drawings.

### DETAILED DESCRIPTION OF EXEMPLARY EMBODIMENTS

Exemplary embodiments include systems and methods providing indicators in an interactive programming guide. In exemplary embodiments, the systems and methods described herein can provide icons or indicators that are inserted into an interactive programming guide. The icons or indicators can include a variety of descriptions associated with a particular program in the IPG. For example, the descriptions can include but are not limited to: a program that has been recorded, to be recorded, viewed, selected by a manual search of a transcript selected by an automatic system search, a wish-list, and a season pass. In the example of a wish list, the icons can include a specific indication of a particular actor or director. In exemplary embodiments, the indicators can be in the form of color coding text associated with a particular program in the IPG. In exemplary embodiments, a subscriber (or user of the service subscribed to) can perform a search of the IPG based on icons. In the description that follows, the term “subscriber” is used, but it should be appreciated that a user need not be the subscriber to take advantage of the services offered to the subscriber as described herein. For example, the subscriber can filter the IPG to display to show only programs that are to be recorded or programs that have a particular actor. As such, the viewing area of the IPG can be reduced to display only those programs based on the filtering criteria. In exemplary embodiments, the systems and methods described herein can also include indicators that there are icons present in a particular time slot or grid of the IPG, but are not in the viewing area of the IPG. For example, an arrow can be displayed in the viewing area of the IPG, the arrow indicating that there are icons out of the viewing range of the IPG.

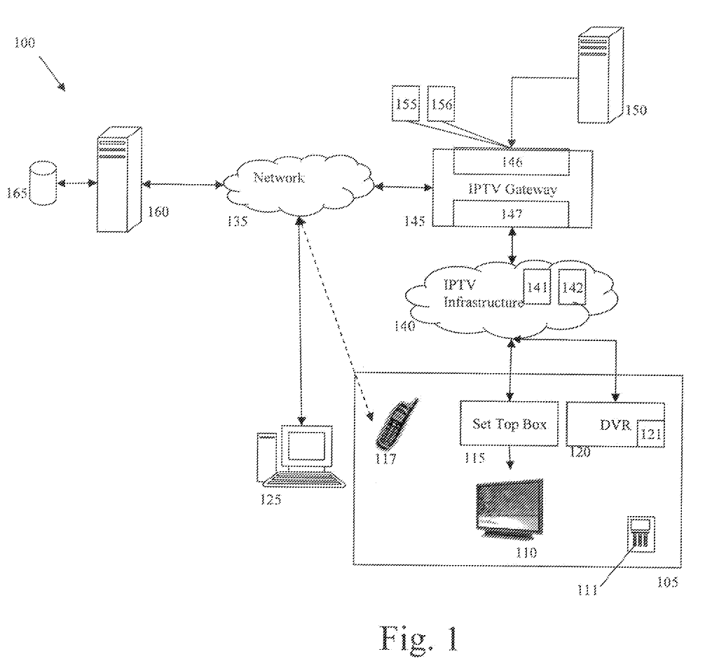

Turning now to FIG. 1, a block diagram of an exemplary system 100 for providing IPG indicators is now described. For ease of illustration, the system 100 of FIG. 1 depicts a simplified network infrastructure. In addition, for ease of illustration, the system 100 is described implementing an Internet Protocol Television (IPTV) system for reception of programming and scheduling. It is understood that the systems and methods described herein can implement television and program-viewing systems other than IPTV. For example, the system 100 can implement cable, satellite and antenna.

Furthermore, it is understood that a variety of network components/nodes may be utilized in implementing the embodiments described herein. For example, in exemplary embodiments, the system 100 includes a means for accessing network services for multiple disparate devices using a single sign on procedure. Therefore, the system 100 manages accounts, each of which is established for a community of devices and/or device subscribers, such as those devices and subscribers in a subscriber location 105, which may include a communications device 110 (e.g., an IPTV-enabled television) coupled to a computing device, such as a set top box 115. The communications device 110 and the set top box may be separate devices or integrated into a single device. Where the communications device 110 is IPTV-enabled, the set top box 115 includes a processor that provides bi-directional communications between an IPTV infrastructure 140 and the communications device 110 and decodes the video streaming media received as content programming and onscreen programming information, from a content services provider server 160, discussed further herein. Other services can be provided to the subscriber location 105, such as, but not limited to phone services, network services and other exemplary services such as the IPG indicator services that can be implemented via the communications device 110. The accounts may thus include phone, network access and IPTV services and may be used to provide access to the IPG indicator services as described further herein. Furthermore, in exemplary embodiments, one of the devices (e.g., the communications device 110) can be provisioned for the network services described herein by associating a device identifier of the communications device with a respective account. The account, in turn, identifies each of the communications devices belonging to the community and provides other information as described herein. Furthermore, it is appreciated that other devices, such as a subscriber computer 125, can be further included in the community of devices established for the subscriber location 105. It is appreciated that the subscriber computer 125 can be local to the subscriber location 105 or can represent any other remote computer that can be used to access the services described herein. It is further appreciated that other remote devices can be implemented to access the services described herein, such as but not limited to a cellular telephone (e.g., a 3G cell phone), a personal computer, a laptop computer, a portable computing device (e.g., personal digital assistant), and a digital music player (e.g., MP3 player), collectively represented as a device 117. As discussed further herein, an IPG indicator services interface can be rendered on any of the above-referenced devices to implement the IPG indicator services in accordance with exemplary embodiments.

In an exemplary embodiment one of the devices, such as the communications device 110 (and the set top box 115, in combination) can be used to establish account services, such as the IPG indicator services described herein. An account record may be generated for the subscriber at the subscriber location 105, which identifies the subscriber and the account for which the services (e.g., basic account services as described above and the IPG indicator services described herein). Account information and records may be stored in a storage device accessible by an IPTV gateway 145, discussed herein. In exemplary embodiments, the IPTV gateway 145 implements one or more applications for establishing access to and utilizing the IPG indicator services account. Access to the IPG indicator services account may thus be created for a community of communications devices (e.g., the communications device 110) to enable the communications devices to implement the IPG indicator services as described herein. A preferences server 150, which is coupled to the IPTV gateway 145, includes preferences information for the subscriber location 105 as described further herein.

As discussed above, the system 100 of FIG. 1 includes the subscriber location 105, such as the subscriber's household. The subscriber location 105 can include the communications device 110 (e.g., an IPTV-enabled television) in communication with the set top box 115. The subscriber location 105 can further include a personal digital recorder such as a DVR 120, which is in communication with the communication device 110 and the set top box 115. It is understood that the set top box 115 and the DVR 120 may be two separate devices or be a single integrated device. In exemplary embodiments, the DVR 120 is hard disk based, but may have other suitable storage media, such as a cache 121. It is appreciated that the DVR 120 can have other suitable memory devices for receiving and storing programming and scheduling data. Therefore, a “memory” or “recording medium” can be any means that contains, stores, communicates, propagates, or transports the program and/or data for use by or in conjunction with an instruction execution system, apparatus or device. The memory and the recording medium can be, but are not limited to, an electronic, magnetic, optical, electromagnetic, infrared or semiconductor system, apparatus or device. The memory and recording medium also include, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored. It is appreciated that the DVR 120 may be local on the set top box 115 (as described), or networked, or on an allocated media server storage space.

The subscriber location 105 can further include a remote control 111 for control and navigation of the communications device 110. As further described herein, the remote control 111 can be implemented to navigate the DVR management and scheduling services interface. As discussed above, the subscriber location 105 can further include one or more remote devices in its community of devices. For example, the remote devices can include the remote subscriber computer 125. In exemplary embodiments, the remote subscriber computer 125 can be part of the subscriber location 105, or a computer that is accessed remotely in order to access the IPG indicator services for control, management and scheduling of video content (e.g., content for recording on the DVR 120) from the content services provider server 160 to the subscriber location 105 for rendering on the communications device 110. It is therefore appreciated that access to the IPG indicator services can be managed from a location remote to the subscriber location 105. It is understood by those skilled in the art that the remote subscriber computer 125 can include input and output devices, such as but not limited to a display, a mouse and a keyboard. Other devices that can access the IPG indicator services include the device 117. As discussed further below, the aforementioned devices can all interact with an IPTV Infrastructure, such as the IPTV infrastructure 140, and the IPTV gateway 145. It is appreciated that any of the aforementioned devices can implement the IPG indicator services. In exemplary embodiments, the communications devices herein can have a network address associated with the communications devices, such as an addressable uniform resource locator (URL), and an Internet address.

The system 100 can implement the IPG indicator services such that desired content selection, control, management and scheduling can be managed and viewed through the subscriber's IPTV-enabled device, such as the communications device 110, via the set top box 115, the remote devices (e.g., the remote subscriber computer 125, and the device 117) or other suitable device. As such, to coordinate IPTV communication, the system 100 may further include the IPTV gateway 145 that is in communication with the IPTV infrastructure 140. The IPTV infrastructure 140 and the IPTV gateway 145 are used in conjunction to communicate via a network 135. For example, a suitable device (e.g., the communications device 110, the device 117, and the remote subscriber computer 125) at the subscriber location 105 can implement the IPTV infrastructure 140 and the IPTV gateway 145 to communicate with the content services provider server 160 to access data from databases such as a database 165 (described further herein).

The network 135 can be an IP-based network for communication between the content services provider server 160 and the subscriber location 105 using communication devices such as but not limited to the communications device 110 (via the set top box 115, for example). The network 135 can be implemented to transmit content from the content services provider server 160 to the subscriber location 105 via a broadband connection, for example. In exemplary embodiments, the network 135 can be a managed IP network administered by a service provider. The network 135 can also be implemented in a wireless fashion, e.g., using wireless protocols and technologies, such as Wi-Fi, Wi-Max, etc. The network 135 can also be a cellular communications network, a fixed wireless network, a wireless local area network (LAN), a wireless wide area network (WAN), a personal area network (PAN), intranet, metropolitan area network, Internet network, or other similar type of network environment or other suitable network system and includes equipment for receiving and transmitting signals. In other exemplary embodiments, the network 135 can be a circuit-switched network such as a standard public switched telephone network (PSTN).

In exemplary embodiments, the IPTV infrastructure 140 can be an IP-based network that receives network data (e.g., programming content for display on the communications device or recording on the DVR) from the content services provider server 160 and the preferences server 150, and delivers the network data to the set top box 115 for display or other rendering on the communications device 110. Alternatively, the network data can be for display or rendering on the remote subscriber computer 125 or other suitable device, such as device 117.

In exemplary embodiments, as discussed above, the IPTV infrastructure 140 provides an interface between the subscriber location 105 and the IPTV gateway 145. In exemplary implementations, a notification server 141 and a terminal server 142 operate to interface communication between the subscriber location 105 via the set top box 115, and the IPTV gateway 145. For example, in exemplary implementations, the set top box 115 can provide a unique identification number so that the IPTV gateway 145 can route the network data to the set top box 115. In doing so, a message is passed between the notification server 141 and the set top box 115. Furthermore, the IPTV gateway 145 provides an interface between the content services provider server 160, and the IPTV infrastructure 140 and subscriber location 105. In exemplary embodiments, the IPTV gateway 145 handles notifications to the IPTV subscriber location 105 and can further provide a history of the notifications. An IPG indicator services application 155 can reside partially or wholly on the IPTV gateway 145 to handle the notifications as further described herein, hi exemplary embodiments, the IPG indicator services application 155 can further reside partially or wholly on the set top box 115. When the subscriber sets up his/her IPG indicator services on the communications device 110 (or other device in the subscriber location 105, remote device, such as the subscriber computer 125 and device 117), one of the network components of the system 100 (e.g., the set top box 115, or the IPTV gateway 145) can store specific scheduling information that the subscriber has created. For example, as discussed further herein, each subscriber can have different recording schedules and thus access and manipulate viewing and recording information for the DVR 120 via an interface, which can include the indicators as described herein. As such, if the interface is stored on the IPTV gateway 145, messages and notifications can be passed between the subscriber location 105 and the IPTV gateway 145 that include present scheduling and historic scheduling that the subscriber has created in the past. Furthermore, if any changes in the subscribers scheduled recordings have occurred, messages can be passed to the subscriber location 105 (or remote device) to notify the subscriber that a program scheduled to be recorded on the DVR 120 has changed. The subscriber can make changes accordingly. As such, it is appreciated that the messages can include data related to the indicators include in the IPG (e.g., the interface).

In exemplary embodiments, the IPTV gateway 145 can further interface with the various system 100 elements as described herein. For example, the IPTV gateway 145 is in communication with the preferences server 150 to pass notifications and messages (e.g., Email messages) regarding permissions to create and edit DVR management and scheduling information. For example, different members of the subscriber location 105 who share account services may have different recording schedules. For example, one member may have a first unique recording schedule and another member may have a second unique recording schedule with little to no overlap with the first recording schedule. As such, each member can retrieve and edit those different schedules and be properly authenticated to retrieve and edit those schedules. In addition, the different indicators associated with the different schedules can be stored along with the recording schedules.

In exemplary embodiments, the IPTV gateway 145 can include a back end 146 and a front end 147. The front end 147 can be used to implement various provisioning activities such as but not limited to initial provisioning of IPTV addresses for the devices at subscriber location 105. The back end 146 can be implemented for many of the IPG indicator services, such as communicating with the content services provider server 160 to search for content stored in the database 165, and accordingly update the status indicators associated with the subscriber's IPG. The system 100 can retrieve and schedule programming data from, the database 165, and pass messages and notifications to the IPTV gateway 145. As such, the back end 146 can include various elements including but not limited to a caller ID handler, SMS handler, message handler, and provisioning handler.

In exemplary embodiments messages and notification can be sent between die IPTV gateway 145 and the subscriber location 105. In exemplary embodiments, the message and notifications can be implemented via an email message. In exemplary embodiments, the IPTV gateway 145 is responsible for retrieving email messages that have been sent to an IPTV subscriber and providing notification of the reception of the email message to the IPTV subscriber at the subscriber location 105. A notification can be in the form a “pop-up” display window displayed at a suitable device (e.g., the communications device 110) or any other conventional message notification scheme. As discussed above, the IPTV gateway 145 can present a history of the notifications to the IPTV subscriber. The messages can also be used to update the IPG with indicators as the status of the IPG changes.

In exemplary embodiments, the IPTV gateway 145 interlaces with a POP3 infrastructure in order to retrieve email messages that have been directed to an IPTV subscriber. Additionally, the IPTV gateway 145 can interface with the preferences server 150. As described herein, the preferences server 150 is responsible for handling the performance preferences for the system 100 as dictated by the desires of an IPTV subscriber. Further, the IPTV gateway 145 is responsible for retrieving an IPTV subscribers preferences for the set top box 115.

In exemplary embodiments, the IPTV gateway 145 Interacts with the IPTV infrastructure 140 to accomplish the actual transmittal of the email message to the set top box 115. Further, all email notifications that are generated within the system 100 are saved to a log at the IPTV gateway 145. In exemplary embodiments, the subscriber can view a listing of the received email message log on their display device via an application that runs on the set top box 115.

In exemplary embodiments, the front end 147 can include a message center application that is in communication with a message center enterprise Java bean (EJB) and an email handler that are included within the back-end 146. The IPTV infrastructure 140 Is provisioned with the subscriber user account numbers and the set top box 115 identifiers. In exemplary embodiments, the IPTV gateway 145 includes a telephone number-to-account number mapping component, wherein a provisioned telephone number correlates to the IPTV subscriber's primary household telephone number (e.g., to the device 117). The IPTV subscriber's telephone number is further associated with the IPTV subscriber's email address. Further, the telephone number and email address are linked with the subscriber's IPTV account number through a web-provisioning interface that is available within the IPTV gateway 145. The IPTV gateway 145 has the ability to retrieve email messages and any image or audio/video attachments to the message, wherein the messages and the attachments are displayed as notifications on the communications device 110.

In exemplary embodiments, the subscriber is provisioned via a primary email account. The email account may be associated with the telephone number of the IPTV subscriber's primary household telephone number (e.g., the local part of the subscriber's email address can comprise the primary household telephone number). The primary email account may be configured to auto-forward all received email messages to a secondary email account that can be serviced by an email server. After being forwarded to the secondary ennui account, the email message can be configured to be deleted from the sending primary email account.

According to exemplary embodiments, at predetermined time intervals, the back-end 146 periodically polls the email server to ascertain if the email server has received any new email messages. The back end 146 can include a POP3 reader thread, which is configured to periodically read a POP3 mailbox that has been configured to receive IPTV email messages. The back-end 146 can retrieve new email messages from the email server. For each retrieved email message, the back-end 146 saves the text of the email message, and if attached, the first image file attachment to an email log. The IPTV gateway 145 can transmit a notification to the subscriber location 105 that an email message has been received. The IPTV gateway 145 stores the received email message information, thus allowing the IPTV subscriber to retrieve the email message information at a later time period with the use of the message center application. As described herein, messages and notifications can be implemented for a variety of purposes related to the IPG indicator services described herein. For example, notifications can be sent to the subscriber household related to scheduling in which the subscriber may be interested, scheduling conflicts within the subscriber's recording schedule, and capacity issues with the DVR 120, thus changing the associated IPG indicators.

In exemplary embodiments, the IPTV gateway 145 may implement authentication using a high-speed processing device (e.g., a computer system) that is capable of handling high volume activities conducted via communications devices, and other network entities (e.g., parts of the IPTV infrastructure 140, network 135, etc.) via one or more networks (e.g., the IPTV infrastructure 140). The IPTV gateway 145 receives requests from one or more devices from the subscriber location 105 to access network services, such as the IPG indicator services. The IPTV gateway 145 may implement authentication software for restricting or controlling access to network. The IPTV gateway 145 may be in communication with a customer identity system (CIS) database, which stores subscriber credentials (e.g., subscriber names and passwords) established via the IPG indicator services account.

In exemplary embodiments, the system 100 can further include the IPG indicator services application 155 that can reside on the IPTV gateway 145, as mentioned above. In exemplary embodiments, the IPG indicator services application 155 can be implemented by the subscriber to access and set up an interface application 156 to implement the IPG indicator services application 155 (i.e., set up an IPG having status indicators as described herein). The interface application 156 can be implemented to locally or remotely search for and schedule programs for display on the communications device 110 or recording on the DVR 120. The IPG indicators services application 155 and the interface application 156 can thus function in conjunction to provide indicators for the IPG as the status of certain programs change. For example, as further described herein, when the subscriber schedules a program for recording, a “to be recorded” indicator can be inserted in the entry in the IPG corresponding the selected program. When the program is recorded, a “recorded” indicators can replace the “to be recorded” indicator. Furthermore, once the subscriber has viewed the recorded program, a “viewed” indicator can then, replace the “recorded” indicator. It is appreciated that there are many different scenarios for icon insertion and replacement in accordance with exemplary embodiments. For example, a program such as a movie can shown in the IPG (e.g., data as provided, by the content services provider server 160 and database 165 and retrieved, into the IPG as described here) as having several different viewing tunes. If the subscriber views the program, the IPG indicators services application (or the interface4 application 156) can insert a “viewed” indicator into the subscriber's IPG into each entry for the movie thereby informing the subscriber that the subscriber has already viewed the movie. In exemplary embodiments, the subscriber can also select the indicator (e.g., using the remote control 111) to expand the indicator to retrieve data such as when the subscriber viewed the movie and whether or not the movie was recorded on the DVR 120.

In exemplary embodiments, the interlace application 156 can further be implemented to access account information from the IPTV gateway 145 and the preferences server 150. In exemplary embodiments, the IPG indicator services application 155 can include pointers to the content services provider server 160 for accessing scheduling information and for directing content that has been selected to be viewed on the communications device 110 or recorded on the DVR 120. The pointers, in turn, provide access to the schedules stored in the database 165 for streaming to the subscriber's set top box 115 for rendering on the interface application 156. The pointers can also provide data related to the IPG status indicators as described herein, thereby updating the subscriber's IPG as status changes occur. The interface application 156 is shown as residing on the IPTV gateway 145. It is appreciated that the interface application 156 can reside on the set top box 115. In further embodiments, the interface application 156 can reside partially on the IPTV gateway 145 and partially on the set top box 115.

In exemplary embodiments, the interface application 156 also provides access to the IPTV gateway 145, such that messages and notifications can be passed between the subscriber location 105 and the IPTV gateway 145 that include present scheduling and historic scheduling that the subscriber has been created in the past. Furthermore, if any changes in the subscriber's scheduled videos have occurred, messages can be passed to the subscriber location 105 (or remote device) to notify the subscriber that a program scheduled to be viewed has changed. The IPG status indicators can thus be accordingly updated and the subscriber can make changes, if necessary.

In exemplary embodiments, as discussed above, the system 100 further includes the content services provider server 160, which is in communication with the IPTV gateway 145 via the network 135. In exemplary embodiments, the content services provider server 160 is implemented by a host system (e.g., a high-speed processing device) that provides content to its subscribers (e.g., a subscriber of the communications device 110), such as television programs, premium programming services, video on demand content, and internet/Web content (e.g., podcasts, and streaming media). In exemplary embodiments, the content is transmitted to the subscribers (e.g., at subscriber location 105) via a broadband connection over an Internet Protocol (IP)-based network (e.g., network 135). The content services provider server 160 can also provide an onscreen programming guide (e.g., EPG) to customers (e.g., the subscriber of program receiving device 150) that provides information about current and future programming available via the content providers' services. Programming information provided by the onscreen programming guide may include current and future program listings including program titles, primary actors/actresses, begin time, duration of program, a year in which the program was produced, and a brief text description of the program. It is appreciated that the subscriber can then develop a personalized IPG as described herein. The IPG indicator services application 155 in conjunction with the interface application 156 can then be accessed to implement the IPG indicator services. It is therefore appreciated that content retrieved from the content services provider server 160 and database 165 is used in conjunction with the subscriber's personalized IPG with status indicators.

In exemplary embodiments, the content services provider server 160 is coupled to the database 165. In one implementation, the database 165 may be representative of a given play list. A play list is associated with a particular program screen. For example, a play list can be generated for a given screen that is displayed for a view on the communications device 110. As a subscriber is browsing through different channels, and therefore different program content, as each new channel and program content are displayed on the communications device 110, a different play list is accessed by the communications device 110 from the content services provider server 160, which can be via the set top box 115. In exemplary embodiments, play lists can include programming content, as well as programming schedules for the content (e.g., onscreen IPG). In exemplary embodiments, the database 165 stores records of programming events scheduled for transmission to customers' devices, such as the communications device 110. These records, in turn, can be used in conjunction with the communications device 110 to view programs and the DVR 120 in order to schedule recordings, for example.

In exemplary embodiments, the subscriber can sort the subscriber's IPG based on the IPG indicators. For example, the subscriber can use the remote control 111 to sort the IPG based only on “to be recorded” indicators. As such, the IPG can be re-displayed showing only the “to be recorded” indicators. In the same way, the subscriber can set up personalized indicators for particular genres, directors or actors, for example. Therefore, if the subscriber has a favorite actor, the subscriber can display only those indicators in the IPG, which care related to the particular actor. In this way, the subscriber can display movies or programs that include the actor. It is appreciate that the subscriber can further sort the indicators to display programs that have been recorded that include die actor, or programs that are scheduled for future times, which include the actor. It is appreciated that there are numerous ways in which the indicators can be sorted and displayed.

In exemplary embodiments, the IPG indicator services application 155 can be implemented to display indicators related to a season pass or other subscription services to which the subscriber has joined (e.g., a sports subscription). As such, indicators can be inserted into the subscriber's IPG, which indicates which programs are parts of the subscriber's particular subscription.

In exemplary embodiments, the subscriber can elect to have the system 100 display content based on certain display criteria. For example, the subscriber can request to display content that is about to be recorded, or content that has been recorded, in addition, the subscriber can request that this content be compared to a wish list or a season pass that the subscriber may have with a content services provider. In this way, particular indicators can be displayed based on a comparison as described herein.

In exemplary embodiments, the subscriber can also set up indicators based on programs that have not been released yet. For example, the content services provider can release limited information related to programs that have not yet been released. The subscriber can then set up an indicator based on the particular unreleased program. Therefore, when the program is released, when it is included in the IPG, it can further include the customized indicator, thereby notifying the subscriber that the program was one that the subscriber had interest before it was released.

In exemplary embodiments, upon a request from the subscriber location 105, the IPTV gateway 145 can coordinate obtaining the acquired data from the database 165 and provide the acquired data for display and rendering at the subscriber location 105. It is appreciated that the coordination of acquiring the data and ultimately displaying the data on the communications device 110 (or other device) is implemented via the IPG indicator services application 155.

in exemplary embodiments, upon a request from the subscriber location 105, the IPTV gateway 145 can coordinate obtaining the content from the database 165 and provide the acquired data for display and rendering at the subscriber location 105. As described, the coordination of acquiring the data and ultimately displaying the data on the communications device 110 (or other device) is implemented via the IPG indicator services application. 155. Furthermore, the IPG indicator services application 155 coordinates the transfer of the program data from the database 165 for rendering on the communications device 110.

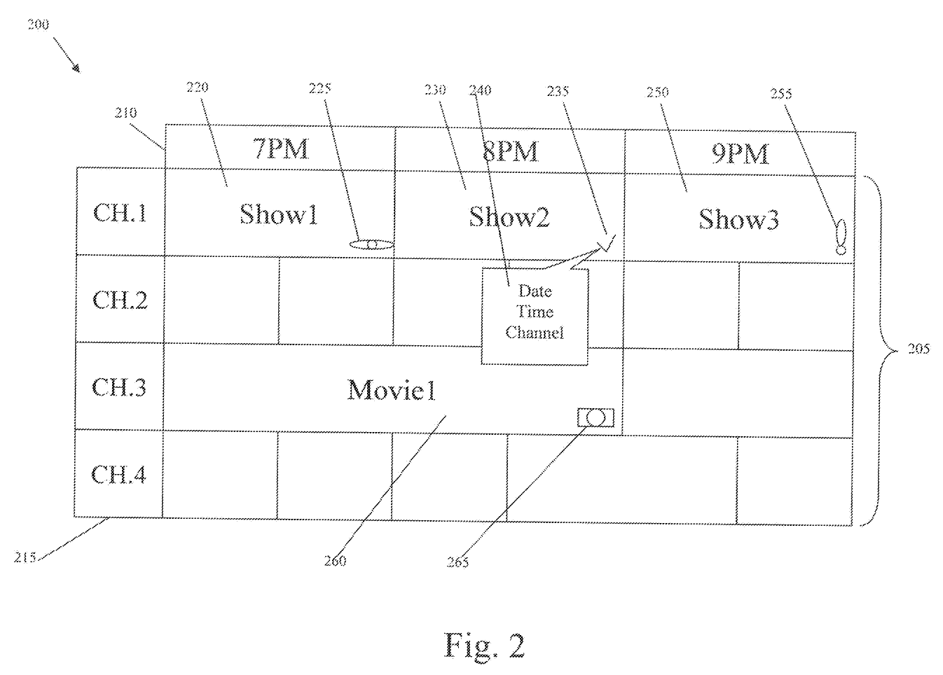

FIG. 2 illustrates an example of a screen shot of an exemplary interactive programming guide (IPG) 200 having program status indicators. The IPG 200 can include a series of program entries 205, each associated with a time 210 and a channel 215. As illustrated the IPG 200 has a Show1 program, entry 220 having a “watching” indicator 225 indicating that the program is currently being viewed. As further illustrated the IPG 200 has a Show2 program entry 230 having a “watched” indicator 235 indicating that the program has been watched. As described above, the subscriber can use the remote control 111 to select the indicator 235 and retrieve data regarding when and where the subscriber bad viewed the program, as indicated by the information box 240. As further illustrated the IPG 200 has a Show3 program entry 250 having a “to be recorded” indicator 255 indicating that the program is to be recorded at the particular time slot on the IPG 200. FIG. 2 further illustrates a Movie1 program entry 260 having a “recording” indicator 265 indicating that the program is currently being recorded on the subscriber's DVR 120. As described above, it is appreciated that there are many indicators that can be inserted into the IPG 200. For example, the subscriber can set up icons for a favorite actor. Furthermore, the subscriber can further sort the IPG 200 by the actor icon and whether the actor is going to be in any further upcoming programs.

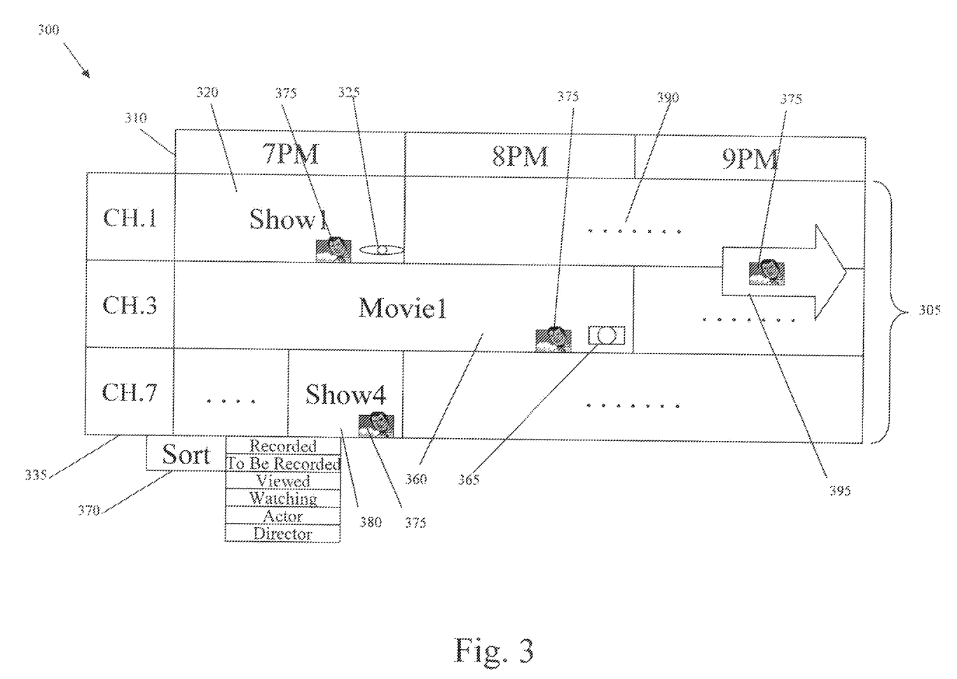

FIG. 3 illustrates an example of a screen shot of an exemplary interactive programming guide (IPG) 300 with sorted indicators. Similar to the IPG 200 of FIG. 2, the IPG 300 can include a series of program entries 305, each associated with a time 310 and a channel 335. In the example IPG 300 illustrated, the subscriber has selected, via a pull-down program guide 370, to sort the IPG 300 by a favorite actor as illustrated by the “actor” indicator 375. As such, the IPG 300 has been resorted as compared to the IPG 200 to display only the program entries having the “actor” indicator 375. As illustrated, the IPG 300 still displays the Show1 program entry 320 (Show1 program entry 220 from FIG. 2), which includes the “watching” indicator 325 as well as the “actor” indicator 375. As further illustrated, still further displays the Movie1 program entry 360 (Movie 1 program entry 260 from FIG. 2) having the “recording” indicator 365 indicating that the program is currently being recorded on the subscriber's DVR 120. In addition, the IPG 300 includes a program entry. Show4 380 with the “actor” indicator 375. It is therefore appreciated that the IPG 300 as sorted by the “actor” indicator 375 is displayed only illustrating the program entries that include the favorite actor. It is further appreciated that as such, there may be empty slots which can be include in the IPG 300 such as the empty slot 390, which can be included in several places in the IPG 300. Since the subscriber desires to find all program entries that include the “actor” indicator 375 (i.e., that are available from the content services provider server 160), a further indicator 395 can be displayed on the IPG 300 alerting the subscriber that there are further program entries that are not in the viewing range of the subscriber. The indicator 395 is illustrated as an arrow pointing in the direction where there are additional program entries. Furthermore, the indicator 395 includes the “actor” indicator 375 alerting the subscriber of the type of indicator that is out of the viewing range. It is therefore appreciated that if the subscriber does not sort the IPG 300, the indicator 395 can include all the types of indicators that are included in the IPG 300 out of the subscriber's viewing range.

FIG, 4 illustrates a flow chart of an IPG indicator method 400 in accordance with exemplary embodiments. At block 410, the IPG indicator services application 155 receives data from the content services provider server 160 and database 165 to populate the subscriber's IPG. At block 420, the IPG indicator services application 155 receives a request from the subscriber to populate the program entries of the IPG with status indicators. It is appreciated that this may be a one-time request to associate default status indicators in the IPG. It is further appreciated that this request may occur each time the subscriber associates a customized indicator with, the IPG as described herein. Regardless of the manner in which the request is received, at block 430, the IPG indicator services application 155 populates the program entries with the indicators. At bock 440, the IPG indicator services application 155 resorts the IPG in response to receiving a request from the subscriber to sort the IPG in accordance with indicators.

The exemplary embodiments described herein have included icons inserted into the program entries as indicators as to the status of the program. It is appreciated that in other exemplary embodiments, color-coding of the program entries can be implemented to indicate the status of the program. It is appreciated that other types of indicators can be implemented in further exemplary embodiments.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. In an Internet Protocol-enabled device communications system having a graphical user interface including a display and a selection device, a method of providing and selecting from a program guide on the display, the method comprising;
retrieving a set of program guide entries for the program guide, each of the program guide entries representing programs that have at least one indicator associated with the program guide entry and illustrating the status of the programs;
determining that a subset of the program guide entries represent programs include a particular status that includes a particular status indicator; and
displaying the status indicator adjacent each program guide entry of the subset of program guide entries.

2. The method as claimed in claim 1 further comprising:
receiving a selection signal indicative of the selection device pointing at a selected program guide entry form the set of program guide entries; and
in response to the signal, retrieving program data associated with the selected program guide entry; and
presenting an expanded view of the program guide entry on the display.

3. The method as claimed in claim 2 wherein the expanded view includes data fields including data related to the program.

4. The method as claimed in claim 1 wherein the program guide entries include at least one of the runtime of the program.

5. The method as claimed in claim 4 wherein the program guide entries include a data field for the status indicator.

6. The method as claimed in claim 5 wherein the status indicator is a graphical representation of the status of the program.

7. The method, as claimed in claim 5 wherein the data field is populated with the status indicator when the program has attained the associated status.

8. A system for displaying an interactive program guide on an Internet Protocol-enabled device, the system comprising:
a display associated with the Internet Protocol-enabled device;
a processor for displaying the interactive program guide with program status indicators on the display, wherein the processor;
retrieves a set of program grade entries for the program guide, each of the program guide entries representing programs that have at least one indicator associated with the program guide entry and illustrating the status of the programs:
determines that a subset of the program guide entries represent programs include a particular status that includes a particular status indicator; and
displays the status indicator adjacent each program guide entry of the subset of program guide entries.

9. The system as claimed in claim 8 wherein the processor further:
receives a selection signal indicative of the selection device pointing at a selected program guide entry form the set of program guide entries; and
in response to the signal, retrieves program data associated with the selected program guide entry; and
presents an expanded view of the program guide entry on the display.

10. The system as claimed in claim 9 wherein the expanded view includes data fields including data related to the program.

11. The system as claimed in claim 8 wherein the program guide entries include at least one of the runtime of the program.

12. The system as claimed in claim 11 wherein the program guide entries include a data field for the status indicator.

13. The system as claimed in claim 12 wherein the status indicator is a graphical representation of the status of the program.

14. The system as claimed in claim 12 wherein the data field is populated with the status indicator when the program has attained the associated, status.

15. A computer program product for displaying an interactive program guide on an Internet Protocol-enabled device, the computer program product including instructions for causing a computer to implement a method, the method comprising:
retrieving a set of program guide entries for a program guide, each of the program guide entries representing programs that have at least one indicator associated with the program guide entry and illustrating the status of the programs;
determining that a subset of the program guide entries represent programs include a particular status that includes a particular status indicator; and
displaying the status indicator adjacent each program guide entry of the subset of program guide entries.

16. The computer program product as claimed in claim 15, wherein the method further comprises:
receiving a selection signal indicative of a selection device pointing at a selected program guide entry form the set of program guide entries; and
in response to the signal, retrieving program data associated with the selected program guide entry; and
presenting an expanded view of the program guide entry on the display.

17. The computer program product as claimed in claim 16 wherein the expanded view includes data fields including data related to the program.

18. The computer program product as claimed in claim 15 wherein the program guide entries include at least one of the runtime of the program.

19. The computer program product as claimed in claim 15 wherein the program guide entries include a data field for the status indicator.

20. The computer program product as claimed in claim 16 wherein the status indicator is a graphical representation of the status of the program.
